(19) United States
(12) Patent Application Publication
(10) Pub. No.: US 2026/0337076 A1
(43) Pub. Date: Oct. 29, 2026

(54) FACILITY FOR TREATING WASTEWATER AND BUILDING COMPRISING SUCH A FACILITY

(71) Applicants: SOPREMA, STRASBOURG (FR); AQUATIRIS, BREAL-SOUS-MONTFORT (FR)

(72) Inventors: Pierre-Etienne BINDSCHEDLER, STRASBOURG (FR); Martin WERCKMANN, STRASBOURG (FR); William BERRY, STRASBOURG (FR); Arthur COLLARD, STRASBOURG (FR); Ulrich INDJEGNET, BISCHHEIM (FR); Elodie MAILLARD, SCHILTIGHEIM (FR); Lionel SINDT, MUHLBACH SUR MUNSTER (FR)

(21) Appl. No.: 19/114,434

(22) PCT Filed: Sep. 22, 2023
(86) PCT No.: PCT/EP2023/076213

§ 371 Date: Mar. 21, 2025

(30) Foreign Application Priority Data
Sep. 23, 2022 (FR) FR2209671

(51) Int. Cl. C02F 9/00; A01G 31/02; C02F 1/00; C02F 1/50; C02F 3/00; C02F 3/12; C02F 3/32

(52) U.S. Cl. CPC C02F 9/00; A01G 31/02; C02F 1/004; C02F 1/006; C02F 1/50; C02F 3/006; C02F 3/1294; C02F 3/327; C02F 2203/002; C02F 2203/006; C02F 2209/003; C02F 2209/40; C02F 2209/44; C02F 2301/046; C02F 2303/04

(57) ABSTRACT

The present invention relates to a facility (1) for treating wastewater (EM) from a building (2). This facility comprises means for collecting waste water (EM), a phyto-purification treatment module (6) which is positioned on the roof (21) of the building (2) and is configured to convert the wastewater (EM) into purified water, and means (10) for recirculating the purified water, preferably treated water (ET), in at least one interior or local circuit (B1) for the reuse of said treated water (ET) inside or in the vicinity of said building (2), and/or for discharging said treated water (ET), by default or due to an excess, into an external network (B) for sanitising or disposing of wastewater.

The present invention falls within the field of water purification. It relates more particularly to a facility for treating wastewater from a building, and to a building including such a facility.

With today's ever-growing urban population, wastewater treatment is a recurring priority health issue. Specifically, the growing urban population is increasing the volume of wastewater to be treated in municipal purification systems. Added to this is the increasing scarcity and cost of water resources.

Furthermore, the increasing number of buildings in towns and cities, and their “concretization”, lead to the waterproofing of the ground, generating a rapid and voluminous influx of water into the purification system, in particular in the event of intense rainfall, notably for unitary networks.

These high-volume wastewater streams from the urban population, and also exceptional climatic events such as drought or heavy precipitation, have an impact on the functioning of urban wastewater treatment and purification infrastructures, notably water treatment plants.

Consequently, the collection, transportation and purification of wastewater, notably household wastewater purification, by these water treatment infrastructures is becoming increasingly complex. It has been found that the risk of these infrastructures becoming saturated and the risk of purification systems overflowing is constantly increasing, notably in urban areas.

Specifically, urban areas are growing, suburbanization is accelerating, and existing purification infrastructures have become undersized. Two solutions may be envisaged: either resize them (involving billions of euros of investment), or seek to limit the volumes sent to communal central purification plants.

Consequently, a simple solution, suitable for the urban environment, for managing and treating wastewater needs to be found, to limit the disruption caused to the current wastewater management and purification infrastructures.

Furthermore, in an eco-responsible logic of sustainable development and preservation of planetary resources, the current trend consists in trying to reclaim available wastewater as much as possible, in particular for use in a context of suitable sanitary requirements, notably less stringent, for example in building sanitary flushing or for the irrigation of crops or green spaces (for example for France: Decree of Jun. 25, 2014, modifying the Decree of Aug. 2, 2010 relating to “l'utilisation d'eaux issues du traitement d'épuration des eaux résiduaines urbaines pour l'irrigation de cultures ou d'espaces verts” [the use of water derived from urban wastewater purification treatment for the irrigation of crops or green spaces]).

The term “wastewater” corresponds to the “raw water” that flows directly out of communal or individual buildings. Wastewater is formed from household wastewater, known as “gray water”, and black water, known as “sewage”.

“Black water” comes from toilets and washrooms in buildings. Black water is formed from a mixture of solid components, notably fecal matter, and liquid or dissolved components in a liquid medium, notably urine.

“Household” or “gray” water is mainly generated by showers, washbasins, washing machines and dishwashers installed in these buildings. Gray water is lightly polluted and in particular free of fecal or urine contamination. As a result, there is considerable potential for reusing household water, notably for use in sanitary flushing systems or for the irrigation or watering of green spaces.

Thus, the treatment and reclamation, if possible locally, of wastewater, and in particular domestic wastewater, constitute major challenges for the preservation of water resources and the limitation of the negative impact of high-density human presence, in particular in urban areas where the volume of wastewater, notably domestic wastewater, produced is significant.

There is already a wide range of household wastewater treatment systems allowing it to be redistributed directly into urban buildings. These building wastewater treatment systems comprise at least one means for recovering said water, followed by a means for treating said water and a means for redistributing it into the sanitary toilet, irrigation or crop watering network.

However, these known wastewater treatment systems are generally:
of complex structure, with a multitude of conveying pipes and storage or treatment tanks, proving to be complex to manage the transfer, feed and distribution of the wastewater to be treated within the purification network;
of a bulky structure with a consequent deployment on the ground or within the building, which generates a loss of availability of the spaces thus occupied in and near the building, for another use,
high energy consumption for its operation, notably for actuating the feed valves, circulating through the treatment filters, and transferring and storing the water,
high manufacturing and installation costs,
visually unesthetic and detract from the building's outer and/or inner appearance within the urban landscape.

Furthermore, the known building wastewater treatment systems require regular maintenance checks, in particular to take into account the effects of freezing/thawing on their functioning, and the risks of saturation or even blockage of pipes or filters, when the influx of wastewater is too great.

Known systems having at least some of the abovementioned limitations are disclosed, for example, in the following documents: CZ 306199, FR 3105208, U.S. Pat. No. 7,754,079 and US 2009/001002.

There is thus a currently unsatisfied need for an improved device for treating the wastewater from a building, in particular its domestic or gray wastewater, allowing said water to be reclaimed and used safely for toilet flushing in the building or for watering green spaces, which is simple in structure, takes up little or minimal space, is easy to maintain and manage, has no negative impact on the environment and has an acceptable or even visually appealing appearance within the urban landscape.

The main aim of the present invention is to respond at least partially, and preferentially substantially totally, to the abovementioned need.

To this end, the present invention relates to a facility for treating building wastewater, characterized in that it comprises:
wastewater collection means,
a pretreatment module configured to transform said wastewater into pretreated water,
a phytodepuration treatment module, positioned on the roof of the building and configured to transform pretreated water into purified water,
a means for storing said purified water, advantageously fitted with a microbiological disinfection means configured to transform the purified water into treated water, and
means for recirculating the purified water, or where appropriate treated water, in at least one inner or local circuit for reuse of said purified or treated water in or around said building, and/or for discharging said purified or treated water, by default or due to an excess, into an external purification or sewerage network, the treatment module comprising at least one saturated/unsaturated flow planted filter.

The wastewater treatment facility of the invention has a simplified structure and requires little time and resources for management and maintenance by an operator, notably for the phytodepuration treatment module, which has virtually autonomous operation over time.

Furthermore, the space taken up by the facility of the invention within the building is limited, notably due to the installation of the treatment module by phytodepuration on the roof and a restricted number of storage means. Thus, the volume taken up by the facility of the invention within the building is optimized to limit its deployment in valuable areas of the building, favorably suitable for another use.

Furthermore, the phytodepuration treatment module on the roof of the facility of the invention also allows rainwater to be collected directly and simply, in addition to the wastewater to be treated, to create a buffer zone, to improve the building's thermal insulation, and even its soundproofing, and to enhance its esthetic appeal by giving it a “green” cachet and an ecological stamp, through the installation of a planted area on the roof. This vegetated area, in the form of a planted aquatic environment, also provides the building with specific thermal insulation and cooling properties at roof level. Due to its specificity, it also contributes toward urban biodiversity.

Furthermore, the facility of the invention allows energy consumption and building charges to be limited by recycling the majority of the wastewater, notably household wastewater. In particular, by limiting or avoiding the use of drinking water for purposes not involving direct contact with people, it is possible to reduce consumption of this resource, which is currently becoming more expensive and needs to be preserved.

In this similarly eco-responsible manner, the facility of the invention contributes toward depolluting and refreshing the atmosphere in the vicinity of the building, and toward improving the urban landscape, notably through the presence on the roof of plants from the phytodepuration treatment module.

The facility of the invention thus forms a simple and efficient means for treating a building's wastewater, allowing it to be recycled and reused locally as a water and hydraulic resource, with priority given to reusing said treated water in or around said building, notably, for example, in the network of sanitary toilets of said building, in any facilities for cleaning vehicles, the building or its surroundings, or in an irrigation or watering network, optionally automated, for surrounding green spaces or plants installed on balconies, for example.

The facility of the invention is also environmentally friendly. The facility of the invention combines esthetic appeal with eco-responsible design, and is designed to preserve the planet's water resources, without however compromising the safety, comfort and water usage needs of the population, notably those in densely populated areas.

The invention will be better understood, by virtue of the description hereinbelow, which refers to preferred embodiments and variants, given by way of nonlimiting examples, and explained with reference to the appended schematic drawings, in which:

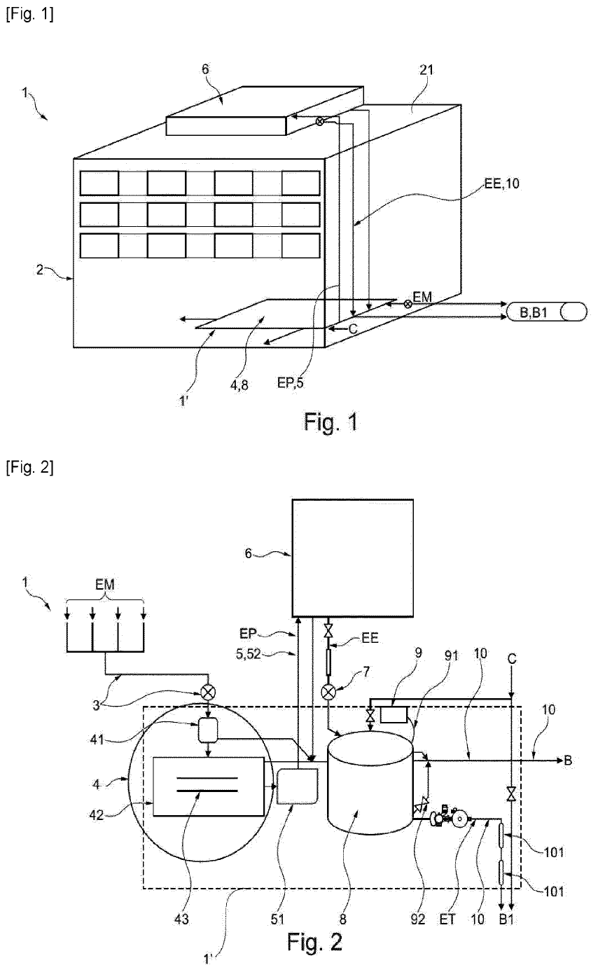

FIG. 1 represents a schematic perspective view of a building fitted with a wastewater treatment facility according to the invention,

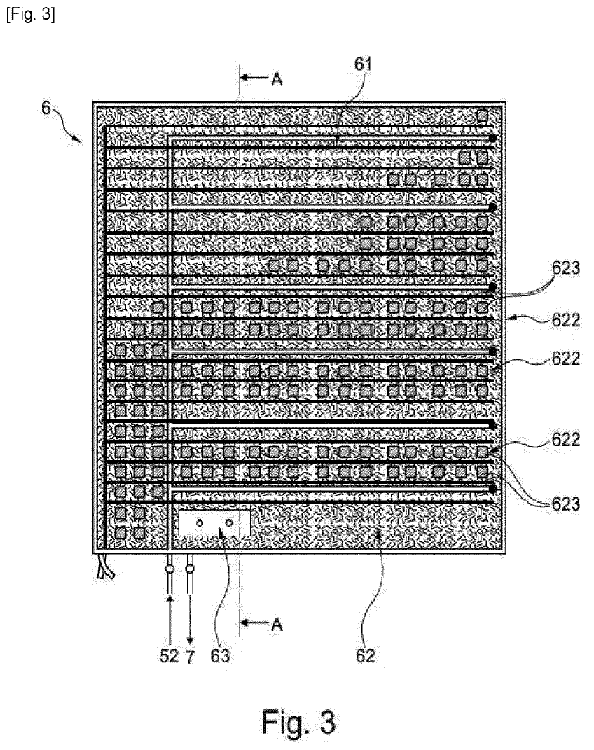

FIG. 2 represents a schematic functional view of a household water treatment facility of the invention,

FIG. 3 represents a schematic top view of one embodiment of the phytodepuration treatment module,

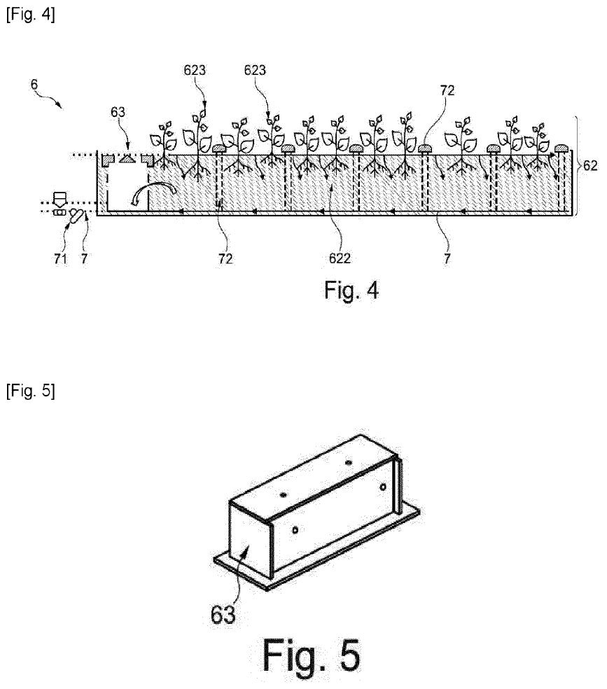

FIG. 4 represents a schematic cross-sectional view along A-A of the phytodepuration water treatment module shown in FIG. 3,

FIG. 5 is a perspective view of an overflow means forming part of the module shown in FIGS. 3 and 4.

In the present patent application, the term “building” denotes mainly and preferentially collective buildings, such as apartment blocks, tertiary or professional buildings, but may also refer to individual buildings, such as detached houses.

Similarly, the term “household water” denotes lightly polluted water from showers, washbasins, washing machines and dishwashers, without fecal or urinary contamination, in liquid form overall, but which may have solid components such as food or organic waste/residue, head hair, bodily hair, or natural or synthetic fibres.

The term “pretreated water” denotes water which has undergone pretreatment, advantageously by mechanical filtration, to remove coarse solid or viscous matter in flotation or suspension, notably also excess grease and oil. Such pretreatment may or may not be useful or necessary, as a function of the nature and quality of the wastewater to be treated.

Similarly, the term “purified water” denotes water that has been pretreated after passing through the phytodepuration treatment module, and which has undergone a phytodepuration treatment. Phytodepuration is a water purification treatment involving water depollution by suitable plants and by the microorganisms associated with the root systems of these plants. Examples of how phytodepuration is performed are notably described in documents U.S. Pat. No. 6,277,274, FR 2942791 and WO 2021/018629.

The term “treated water” denotes herein water purified within the storage means after application of the microbiological disinfection means. For application of the invention in France, the treated water has a microbiological quality that complies with the standard set by the Agence Régionale de la Santé (ARS) and the Decree of Aug. 2, 2010 relating to the use of water derived from urban wastewater purification treatment for the irrigation of crops or green spaces, and the French Decree of Jan. 11, 2007 relating to the limits and quality references for raw water and water intended for human consumption mentioned in articles R. 1321-2, R. 1321-3, R. 1321-7 and R. 1321-38 of the French Public Health Code. In the context of an application of the invention in another country, the treated water ET will have a microbiological quality meeting the regulations and sanitary criteria in force locally by a corresponding adaptation of the means of the invention, which is within the reach of a person skilled in the art having knowledge of the present invention.

In general and irrespective of the country in which the invention is implemented, the “treated water” obtained at the end of treatment by facility 1 has at least a concentration of pollutants and microorganisms permissible for:
being discharged directly into the environment (watering or irrigation), without the risk of polluting the environment, notably the water table, and/or,
return to a residential network and as a supply for toilet flushing, when authorized by local regulations.

As can be seen in FIG. 1 or FIG. 2, the present invention relates to a treatment facility 1 for wastewater EM from a building 2, characterized in that it comprises:
wastewater EM collection means 3,
a pretreatment module 4 configured to transform said wastewater EM into pretreated water EP,
a phytodepuration treatment module 6, positioned on the roof 21 of building 2 and configured to transform the pretreated water EP into purified water EE,
a means 8 for storing said purified water EE, advantageously fitted with a microbiological disinfection means 9 configured to transform the purified water EE into treated water ET, and
means 10 for recirculating the purified water EE, or where appropriate the treated water ET, in at least one internal or local circuit B1 for reusing said purified water EE or treated water ET in or around said building 2, and/or for discharging said purified water EE or treated water ET, by default or due to an excess, into an external purification or sewerage network B,
the phytodepuration treatment module 6 comprising at least one planted filter 62 with saturated/unsaturated flow.

The treatment facility 1 has a simple structural configuration with a reduced number of means, but is nevertheless capable of transforming wastewater EM, notably household wastewater, at least into purified water EE, preferentially into treated water ET of sufficient microbiological quality for use both internally in the building and in its surrounding area.

The phytodepuration treatment module 6, constituting the component occupying the most ground area, is installed on the roof 21. Thus, as the treatment facility 1 is preferentially deployed predominantly on the top of the building (flat roof 21), its deployment on the ground is thus limited, which favors the freeing up of space and the possibilities of developing natural areas in the urban landscape in the vicinity of the building, in addition to providing a green space at the roof level 21. Conversely, by installing only the phytodepuration treatment module 6 on the roof, the roof structure and bearing elements of the building are not overstressed. In particular, the pretreatment module 4 (with its buffer storage tank 42) and the storage means 8, and also optionally other elements of the facility 1 (other than module 6), may be arranged in a room or equivalent space 1′ in the basement of the building 2 including facility 1 (see FIGS. 1 and 2).

The hydraulic operating principle of the or each planted filter 62 is of unsaturated/saturated type. During the supply phases, water flows vertically and gravitationally into the porosity of the gravel pack 622 planted with plants 623 of the filter plant 62 concerned, until saturation of the porosity of said pack over a variable height depending on the volume of water to be treated. Saturation combined with a hydraulic residence time contributes to the purification performance of the planted filter 62.

When the treatment is complete (by measuring a residence time), the planted filter 62 under consideration is completely or partially drained, thus allowing the reoxygenation thereof. The alternating filling and emptying phases, preferentially combined with feed-water tank feeding, allow oxygenation conditions in said filter to be varied, and thus create aerobic/anaerobic conditions in the filter, favorable to treatment. A more precise description of this operating mode of a planted filter 62 implemented in the context of the invention is given hereinbelow.

In addition to preserving the environment by reusing available water resources, the treatment facility 1 ensures the quality of treated water for a given application. The treatment facility 1 also helps to improve the quality of the urban atmosphere, and contributes toward depolluting and improving the esthetics of the urban landscape, notably by allowing plants to develop and grow on the roofs of buildings.

The facility 1 incorporates a pretreatment module 4 and a storage means 8. Furthermore, to ensure water circulation between the various functional components of the facility 1, the latter may include, in addition to the wastewater EM collection means 3, also means 5 for transferring the pretreated water EP and/or means 7 for collecting and conveying the purified water EE.

Specifically, by using gravity prefiltration and free-flow filtration through a planted filter, only limited energy consumption (lifting) is required for these two functions.

According to an advantageous embodiment of the invention, also apparent from FIGS. 1 and 2, the facility 1 more precisely comprises:
means 3 for collecting wastewater EM, in particular at least household wastewater EM, configured to feed the pretreatment module 4,
means 5 for transferring pretreated water EP (from module 4) to the phytodepuration treatment module 6, these transfer means 5 advantageously comprising at least one self-cleaning lifting pump 51 in combination with a lifting column 52,
means 7 for collecting purified water EE and conveying it to storage means 8 fitted with means 9 for microbiological disinfection, transforming the purified water EE into treated water ET,
means 10 for recirculating said treated water ET into at least one circuit B1 as a supply for flushing toilets in building 2 and/or at least one device for watering or irrigating crops, for example plants, window boxes and/or cultivated green spaces or amenity areas, located in or around said building 2, and/or for discharging treated water ET into the external purification or sewerage network B, i.e. normally the public sewerage network.

Preferentially, the means 5 for transferring the pretreated water EP to the phytodepuration treatment module 6 are configured and controlled to perform feed-water tank feeding of the planted filter(s) 62, and the means 7 for collecting the purified water EE and conveying it to the storage means 8 are configured and controlled to perform, in a controlled manner or at regular intervals corresponding to a pre-programmed residence time, partial or total emptying of the purified water EE from the planted filter(s) 62, resulting in the abovementioned alternating phases of filling and emptying of the phytodepuration treatment module 6.

According to a possible feature of the invention, visible in FIGS. 1 and 2, the pretreatment module 4, preferably positioned within the lower part or cellar of the building 2, for example in a technical room 1′ in the basement together with the storage tank 8 and possibly at least a part of their accessory equipment, comprises:
at least one separating means 41 configured to separate wastewater EM from solid waste, notably food or organic waste, for example a self-cleaning separating filter, where appropriate a vortex filter, and,
at least one wastewater EM storage means 42, optionally fitted with mechanical filtration means 43, such as a pre-filtration vat equipped with aeration vents and overflows opening onto the sewer network B, whose discharge is preferentially directed by gravity toward the transfer means (5).

Positioned in the lower part of building 2, the pretreatment module 4 is readily accessible to an operator, notably for inspection purposes, and allows wastewater to be collected from the upper levels of the building 2 simply by gravity, without the need for additional energy-intensive moving equipment.

Furthermore, placing the pretreatment module 4 inside the building 2 protects it from weather and climatic agents, notably freeze-thaw phenomena, and allows it to be preserved over time.

Specifically, the positioning of the pretreatment module 4 in the lower part of the building 2 facilitates the discharge of solid, food-grade waste directly into the drainage network provided for this purpose, after the separation operation via separation means 41.

According to the invention, the separating means 41 physically and mechanically separates solid waste from liquid wastewater EM. Various means known to those skilled in the art for performing this separation may be used.

According to one embodiment compatible with the preceding example, the separation means 41 comprise at least one self-cleaning separating filter. This allows the conveyed solid waste to be roughly separated from the liquid fraction of wastewater EM, in particular of food waste type.

After separation by the separation means 41, the solid waste is directed into the sewer system B by any known suitable means, and the wastewater EM is directed to at least one storage means 42 by any known means, such as pipes or channels.

According to the invention, said at least one storage means 42 is intended for storing wastewater EM prior to transferring it to the phytodepuration treatment module 6. For example, the storage means may consist of a storage tank or vat.

According to a particular embodiment compatible with the preceding examples, the storage means 42 is equipped with a mechanical filtration means 43 allowing additional filtration of wastewater EM and its separation from solid waste. Also, this storage means 42 is constructively configured to prevent the development of flies, mosquitoes and other pest insects.

As shown in FIG. 2, the storage means 42 consist, for example, of a prefiltration vat 42 fitted with at least one mechanical separating filter 43 of the granular filter type, allowing wastewater EM to be separated from solid food waste by vertical filtration through the granular material.

According to the invention, the mechanical separating filter 43 is configured to separate wastewater EM from its solid waste more finely than the separation means 41.

According to an implementation example of a treatment facility 1 that is compatible with the preceding examples, the facility 1 may comprise dispersion and surface distribution means 61 for pretreated water (EP) at the level of the phytodepuration treatment module 6. Furthermore, it may be envisaged that the transfer means 5 comprise at least one self-cleaning lifting pump 51 combined with a lifting column 52, which opens onto said dispersion and surface distribution means 61, which preferentially ensure a substantially homogeneous distribution over the entire surface area of the module 6. These means 61 may consist, for example, in a nonlimiting manner, of extended angular spray nozzles.

According to a particular embodiment, the lifting column 52 is configured and dimensioned to allow the creation of a Venturi effect during the transfer of the pretreated water EP to the phytodepuration treatment module 6, so as to create oxygenation of the pretreated water EP within the lifting column 52. This oxygenation creates micro-bubbles in the pretreated water EP, and also allows homogenization of its transfer and distribution speed within the lifting column 52, so as to discharge this water in a homogeneous distribution and flow through the dispersion means 61.

According to a particular embodiment of the invention, the dispersion means 61 consist of at least one spreading system. For example, and as shown in FIG. 3, the spreading system consists of a network of spreading ramps leading to dispersion nozzles arranged so as to cover the entire surface of the phytodepuration treatment module 6 with the pretreated water EP, and thus in a homogeneous manner.

According to an implementation example of the facility 1 that is compatible with the preceding provisions, the phytodepuration treatment module 6, positioned on the roof 21 of the building 2, comprises:
at least one planted filter 62 with combined vertical+horizontal flow (or also denoted by unsaturated−saturated flow), the supply of pretreated water EP to this/these filter(s) being performed, for example, by means 61 for dispersion and surface distribution (means 61=sprinkler nozzles distributed over the surface of the planted filter(s) 62 and supplied by a network of suitable pipes−example in FIG. 3), and
overflow means 63.

The planted filter 62 may include a single gravel pack 622, or optionally at least two gravel packs 622, for example arranged and fed in parallel, or arranged in series.

The phytodepuration treatment module 6 positioned on the roof 21 makes it possible to improve the esthetics of the local urban landscape and to benefit from a functional green space readily accessible by an operator, and optionally by the residents, without encroaching on building spaces useful for other purposes.

Furthermore, the plant purification module 6 on the roof allows rainwater to be recovered and treated in addition to pretreated wastewater EP. The recovery of rainwater is in line with positive, eco-responsible management of the water available for human use, and thus contributes toward preserving water resources.

As shown in FIG. 3 or FIG. 4, the treatment module 6 comprises at least one saturated/unsaturated flow planted filter 62, allowing biological purification in fine granular media. The operating principle of the planted filter in module 6 is based on hydraulic management (filling/emptying) of the basin containing it, resulting in alternating phases of saturation (anaerobic) and oxygenation (aerobic).

The planted filter 62 comprises either a single gravel pack 622 as represented in FIGS. 3 and 4, or at least two gravel packs 622 positioned in parallel and fed in parallel, all located in a single compartmentalized basin thus forming a unitary module 6, or in several separate basins, thus forming a modular structure planted filter, readily adaptable to varying needs. Filtration of the pretreated water EP is performed through the gravel pack(s) 622. The or each gravel pack 622 is preferentially formed of a filtration medium based on inert aggregates (e.g. charcoal-based) of different particle sizes, in which halophytic plants 623, for instance reeds, grow predominantly or exclusively.

The nature and choice of the filtration medium forming the or each gravel pack 622, i.e. essentially inert aggregates, and also the nature of the plants 623, may be defined by a person skilled in the art as a function of the amount of water to be treated, the desired filtration capacities and the desired quality of the purified water EE.

The principle of phytodepuration water treatment is based on the development of a dense network of halophytic plant rhizomes, which allows the gravel pack(s) 622 to be provided with a microbial growth medium, contributing to the water purification process.

The presence of the halophytic plants 623 acts as a mechanical unclogging device for the surface of the gravel pack, and promotes percolation of the pretreated water EP from the dispersion means 61 into the inert aggregate filtration medium. The pretreated water EP will be drained along the roots toward the base of the gravel pack 622 concerned, while the suspended solids will be retained on the surface, and then mineralized under aerobic conditions during the bed emptying phases, so as to serve as a nutrient for the plants.

Furthermore, water purification is reinforced by the microbiological activity of the rhizome of the plants 623, in addition to the physico-chemical retention of pollutants in the pretreated water EP on the surface of the gravel pack 622 concerned.

Specifically, rhizosphere microorganisms have a biological purifying action, they:
consume or at least degrade organic matter dissolved in pretreated water EP, and
participate in the degradation of nitrogen compounds, phosphates or other trace elements, and likewise in the development mechanism of plants, and where appropriate even heavy metals can be converted into less toxic forms.

Thus, the structure of the phytodepuration treatment module 6 through the planted filter 62 with its gravel pack(s) 622 planted with plants 623 allows the pretreated water EP to be transformed into purified water EE.

According to the invention, in order to ensure the production of purified water EE at the outlet of the phytodepuration pretreatment module 6, a saturated/unsaturated flow planted filter 62 is chosen, which is formed either from a single gravel pack 622 planted with plants 623, or at least two hydraulically separated gravel packs 622 planted with plants 623, arranged in parallel (forming two sub-modules arranged constructively and functionally in parallel and together corresponding to a stage) and operating alternately. Optionally, at least two planted filters 62, forming two stages of module 6 arranged in series, may be envisaged as a function of the desired treatment and operation.

Implementation of the saturated/unsaturated flow planted filter 62 is advantageously based on an even-surface feed-water tank feeding (alternating sequentially) to the gravel pack 622, or to one or other of the two parallel-arranged gravel packs 622 of a single stage of the planted filter 62 (which may also comprise at least two filtration stages in series).

Thus, if there are two gravel packs 62, the pretreated water EP arrives via the dispersion means 61 alternately on one or other of the gravel packs 622. Consequently, with a saturated-non-saturated flow planted filter, one of the gravel packs 622 will be in a “rest phase” with no discharge of pretreated water EP, whereas the other will be in a “feed phase” with a continuous discharge of pretreated water EP. For a planted filter 6 with a single gravel pack 622, these two phases follow each other sequentially.

In the gravel pack 622 in the “feed phase”, the pretreated water EP percolates through the aggregate and rhizome filtration medium for a predefined residence time, to emerge in the form of purified water EE. Simultaneously and in parallel, the other gravel pack 622 is in the “rest phase”, i.e. draining, without being fed with pretreated water EP.

The “resting phase” of a gravel pack 622 allows the suspended matter accumulated during a previous “feed phase” to dry out and mineralize. The resting phase is necessary to promote the regeneration process of its filtering properties by ensuring that the aerobic treatment conditions of the gravel pack concerned are maintained.

In the case of a single gravel pack 622, the two phases (feed and rest) are necessarily sequential.

In the phytodepuration treatment module 6, “rest phases” and “feed phases” with a defined “residence time” are important for its proper operation, reliability and longevity over time, and result in alternating phases of saturation (anaerobic) and oxygenation (aerobic).

For the purposes of the invention, the “residence time” corresponds to the time required to treat the pretreated water EP and transform it into purified water EE, i.e. the time required for the pretreated water EP to come into contact with the gravel pack 622, as a function of its size and the content of the filtration medium (aggregate+plant rhizomes).

Needless to say, although the present invention is directed more particularly toward a module 6 with a single planted filter 62, several planted filters 62 may be operated in parallel or in series according to other implementation variants of the module 6 of the invention, not shown.

According to a first embodiment of the invention represented in the appended figures, the phytodepuration treatment module (6) includes a single planted filter (62) which includes a single gravel pack (622) planted with plants (623) and subjected to alternating phases of filling and partial or total emptying.

According to a second embodiment of the invention, not specifically illustrated but readily deduced from the appended figures, the phytodepuration treatment module (6) comprises at least two planted filters (62), either arranged in series and thus forming two successive filtration stages of the module (6), or arranged and fed in parallel, the two planted filters (62) thus being subjected to successive alternating phases of filling and partial or total emptying.

In the two abovementioned embodiments, as a variant to the presence of a single gravel pack, the or each planted filter (62) of the phytodepuration treatment module (6) may comprise at least two gravel packs (622) planted with plants (623), which are positioned in parallel and fed in parallel, these gravel packs (622) being located in a single compartmentalized basin thus forming a planted filter (62) with a unitary structure, or in several separate basins, thus constituting a planted filter (62) with a modular structure, the various gravel packs being advantageously fed and drained alternately with each other.

As a practical implementation example of a phytodepuration treatment module 6, as shown in FIGS. 3 and 4, the latter may include at least one phytodepuration basin with a total height or depth of about 30 cm, containing a planted filter 62 which constitutes the biological treatment system. The bottom of the gravel pack 622 of said filter is preferentially zero-sloped.

The gravel pack 622, which also forms a growth substrate for planted plants 623, has a height or depth of about 20 cm and incorporates small, inert, supplied mineral aggregates. The planted filter 62 is fed with pretreated gray water EP via a specific irrigation system (dispersion means 61), which is fed by the transfer means 5 over the entire surface area of the planted filter 62. The maximum filling height in this example is 20 cm (maximum water level in the gravel pack). Above this height, an overflow system 63 allows excess water generated by unusually high feed levels or intense rainfall events to be discharged into the wastewater network (network B).

The gravel pack 62 is planted with plants 623 belonging to hardy marsh species, known as halophytic-type macrophytes, selected for example from iris, carex, bulrushes, purple loosestrife and meadowsweet. These particular species, which mainly emerge with their feet in the water, accept regular variations in water level.

The gravel pack 62 is fed intermittently to promote reoxygenation, and the residence time of the water in the gravel pack 62 is advantageously at least 4 hours. Transfer by gravity of the purified water EE at the outlet of the gravel pack 62 toward the storage tank 8 may be controlled, for example, either actively by the intermittent opening of a controlled discharge 7, 71, or passively by means of a hydraulic device of the “siphon-bell” type.

By way of practical example, the gravel pack 62 may include aerobic fixed plants 623 on a fine support, for example 20 cm of pozzolan with a particle size of 3/6 mm. The flow is of the combined type, i.e. vertical (upper fraction of gravel pack 62) and horizontal (lower fraction of gravel pack 62). Feeding with pretreated gray water EP is performed by successive controlled feed-water tanks, the emptying being controlled for example by means of a controlled or programmed solenoid valve 71. Alternating functioning of the filter (notably with no feed during the night, combined with saturated and drained phases) results in controlled biomass development of the planted filter 62.

According to the invention, the dispersion means 61 of the phytodepuration pretreatment module 6 performs the spreading (extensive surface spraying) of the pretreated water EP onto the gravel pack 622 in the “feed phase”. Advantageously, and in addition to the effect of the alternating feed-water tanks, the spreading also contributes to the oxygenation of the filtration medium, which promotes the growth of microorganisms in the rhizosphere and helps to eliminate pathogenic microorganisms and pollutants from the water.

According to the invention, the treatment facility 1 comprises means for managing and controlling the feeding and spreading of pretreated water EP onto the gravel pack(s) 622 of the phytodepuration treatment module 6.

In order to compensate for a rainy episode and the accumulation of rainwater in the gravel pack(s) 622, in addition to the pretreated water EP, the phytodepuration treatment module 6 also comprises an overflow means 63, which may be seen in FIG. 4 and is specifically represented in FIG. 5.

This overflow means (63) allows passive management of the volume amount of water present within the gravel pack (622). Thus, in the event of excessive rainfall which may hinder the purification process within the phytodepuration treatment module 6, notably by saturating the gravel packs 622, the overflow means 63 can either store the excess water until the end of the rainy episode, or discharge it to the external purification system B.

According to a particular embodiment shown in FIGS. 4 and 5, the overflow means 63 is in the form of a hollow, watertight box (or chute) located in module 6 and forming a retention dam at the outlet of said module 6. It is fitted with orifices located at one or more predefined heights and calibrated to regulate discharge and also to prevent the penetration of residues, notably such as leaves, substrate or root debris, into the box.

According to another possible feature of the invention, which is compatible with the preceding examples and embodiments, the means 7 for collecting and conveying the purified water EE are present at the outlet of the at least two gravel packs 622, preferably at the outlet of the overflow means 63 collecting the water which has passed through said gravel packs 622. These collection and conveying means 7 advantageously comprise means for managing the residence time 71 of the pretreated water EP within the phytodepuration treatment module 6.

For example, according to a particular embodiment shown in FIG. 4, the collection and conveying means 7 comprise slotted collection drains facing downward from the phytodepuration treatment module 6, optionally connected to aeration stacks 72 and a solenoid valve 71 controlled to manage the residence time of the pretreated water EP in the gravel pack 622.

Opening the solenoid valve 71 allows the purified water EE produced by the phytodepuration treatment module 6 to be transferred to the tank-type storage means 8. Closing the solenoid valve 71 allows the water to be stored within the phytodepuration treatment module 6 at least for the time required to purify pretreated water EP via gravel pack 622.

According to a preferred embodiment of the invention, the residence time management means 71, for example of the solenoid valve type 71, are combined with mechanical filtration means, for example of the sieve filter type, so as to avoid the discharging into the storage means 8 of purified water EE comprising solid compounds notably originating from the gravel pack 622.

As shown in FIG. 2, the storage means 8 comprises a storage tank arranged at the outlet of the phytodepuration treatment module 6 and fitted with a microbiological disinfection means 9 allowing the purified water EE leaving the module 6 to be transformed into treated water ET complying with the criteria of the health regulations in force locally, for the intended use.

According to an implementation example of the storage means 8, which is compatible with the abovementioned examples, it comprises a means for managing the volume and regulating the supply of water.

For example, the means for managing the volume and regulating the supply of the amount of water comprises a pressure switch intended to manage the supply of the storage means 8 either with purified water EE by phytodepuration, or with water C from the mains supply. Specifically, the storage means 8 must comprise a sufficient volume of water for actuating the microbiological disinfection means 9, and thus, in the event of insufficient volume, the pressure switch allows the storage means 8 to be supplemented with water C from the public drinking water network, or even from another source, natural or otherwise.

According to another advantageous feature of the invention, which is compatible with the abovementioned examples that may be seen in FIG. 2, the microbiological disinfection means 9 comprise a means 91 for injecting a disinfectant solution and a means 92 for monitoring the degree of disinfection 92 of the purified water EE.

According to a particular embodiment shown in FIG. 2, the injection means 91 comprise a piston or pump for injecting a disinfectant solution consisting, for example, of hydrogen peroxide in the form of an aqueous hydrogen peroxide solution. Oxygenation of the purified water EE contained in the storage means 8 allows it to be immediately disinfected, thereby affording treated water ET of microbiological quality meeting ARS standards, for use in the toilet flushing systems of the building 2 or in the watering system for green spaces.

As shown in FIG. 2, according to a particular variant that is compatible with the preceding examples, the means 92 for controlling the disinfection of treated water EE comprise means for continuously checking the operating status of the means 91 for injecting a disinfectant solution.

For example, the means for continuously checking the operating status of the injection means 91 consists of a module for monitoring the volume of disinfectant solution injected into the storage means 8, which is fitted with a device for signalling when the quantity of disinfectant solution in the storage means 8 is insufficient.

The disinfection control means 91 thus affords adequate treatment of purified water EE to obtain treated water ET of microbiological quality meeting current standards, for reuse in circuit B1 for supplying toilet flushes with water or for crop irrigation, for example.

In the treatment facility 1 of the invention, the microbiological quality of the treated water ET is ensured by the correct operation, preferably continuous, of the microbiological disinfection means 9. The permanent injection of a disinfectant solution into the storage means 8 allows the purified water EE to be disinfected and treated to transform it into treated water ET. Consequently, the microbiological quality of the treated water ET is ensured by the disinfection control means 92, which constantly monitors and checks the proper operation of the injection means 91, so as to adjust the volume of solution injected in the event of any shortfall.

Thus, according to the invention, the microbiological disinfection means 9 is configured to ensure a microbiological quality of the treated water (ET) in accordance with the criteria of current health regulations for the intended use.

According to a possible optional feature of the treatment facility 1 of the invention, which is compatible with the abovementioned examples, the discharge and/or recirculation means 10 may comprise a means for additional checking of the microbiological quality of the treated water ET.

The presence of an additional means of checking the microbiological quality of the treated water ET leaving the storage means 8 and circulating in the distribution means 10 is an additional guarantee that the treated water ET complies with the standards or regulations in force in the place where the invention is implemented. It notably makes it possible to check that no microbiological contamination has occurred during circulation in the distribution means 10.

For example, the additional means for checking the microbiological quality of the treated water ET consists of at least one means for collecting water samples, present on the distribution means 10. Collecting samples allows microbiological analysis of the treated water to check that it does indeed comply with the standards. Advantageously, the sampling means is positioned upstream of a multi-way valve connected both to the external purification network B and to the B1 circuit supplying with water the toilet flushes or watering devices of the building 2, so as to be able to direct the water selectively towards the appropriate network as a function of the sample result, needless to say with a preference for circuit B1 if the normative conditions are met.

If, after a water sample has been taken, the quality of the water complies with current microbiological standards, the water is directed toward circuit B1, which feeds the toilet flushes or watering devices in the building 2 via a multi-way valve.

On the other hand, if, after checking, the quality of the water does not meet current microbiological standards, for example as a result of contamination having occurred in the distribution means 10, the water is directed toward the external purification network B via the multi-way valve.

According to another example of possible development of the treatment facility 1, which is compatible with the preceding examples, the discharge and/or recirculation means 10 comprise a network of pipes configured to direct the treated water ET towards the circuit(s) B1 for supplying with water the toilet flushes of building 2 and/or of at least one plant and/or green space watering device located in or around said building 2, and/or toward the external purification or sewerage network B.

According to another possible additional feature of the invention, the discharge and/or recirculation means 10 also comprise, at least upstream of the circuit B1 for supplying with water local toilet flushing and/or watering devices, additional mechanical filtration means 101.

According to a particular embodiment of the treatment facility 1, and in particular to ensure personal safety, the additional mechanical filtration means 101 are, for example, in the form of a sieve filter (for example 150-micron filtration) and/or a zeolite filter (for example 50-micron filtration), as shown in FIG. 2.

In accordance with the invention, for use in the toilet flushing feed circuit B1, additional mechanical filtration means 101 are required so as to comply with current water quality standards.

Preferably, the additional mechanical filtration means 101 are present at least upstream of said feed circuit B1 for the flushing of the toilets of building 2 or the watering devices of the green spaces, so as to ensure by an additional means the quality of the treated water ET intended for this use.

These additional mechanical filtration means 101 thus allow the treated water ET to be filtered off one last time, ensuring the safety of the water purification and disinfection operation, so as to ensure its safety of use by guaranteeing its microbiological quality, before transferring it to the feed circuit B1.

According to another possible advantageous development of the treatment facility 1, the pretreatment module 4, of which the or a storage means 42 for wastewater (EM) and/or the storage means 8 for purified water (EE) preferentially form(s) a part, comprises(s) at least one overflow evacuation system.

The overflow evacuation system allows excess water to be evacuated to the purification network B, thus avoiding saturating or overflowing the storage means 42 or 8 and malfunctioning of the treatment facility 1.

The treatment facility 1 thus allows wastewater EM from a building to be transformed into treated water ET of sufficient microbiological quality for its use in a recirculating feed circuit B1, for local equipment, such as toilet flushing systems in the building 2 concerned or watering systems for green spaces, with minimal alteration to the building's outer environment, favoring eco-responsible means which contribute toward depolluting the atmosphere in an urban environment.

Another subject of the invention, as shown schematically in FIG. 1, is a building 2, notably a tertiary or residential building, for catering or collective housing, characterized in that it comprises a facility 1 for the treatment of wastewater EM, in particular or exclusively of the household wastewater type, produced by its occupants, as described above.

Needless to say, the invention is not limited to the embodiments described and represented in the appended drawings. Modifications remain possible, notably with regard to the constitution of the various elements or by substitution of technical equivalents, without however departing from the field of protection of the invention.

1-23. (canceled)

24. A facility for treating wastewater from a building, which comprises:
means for collecting the wastewater,
a pretreatment module configured to transform said wastewater into pretreated water, positioned in the lower part or cellar of the building and comprising at least one separating means configured to separate the wastewater from solid waste and at least one means for storing the wastewater,
a phytodepuration treatment module, positioned on the roof of the building and configured to transform the pretreated water, transferred via transfer means, into purified water, said treatment module comprising at least one planted filter,
a means for storing said purified water, advantageously fitted with a microbiological disinfection means configured to transform the purified water into treated water, and
means for recirculating the purified water, or where appropriate the treated water, in at least one inner or local circuit for reusing said purified water or treated water in or around said building, and/or for discharging said purified water or treated water, by default or due to an excess, into an external purification or sewerage network,
wherein the facility further comprises means for collecting and conveying the purified water, which comprise means for managing the residence time of the pretreated water within the phytodepuration treatment module,
in that the phytodepuration treatment module also comprises an overflow means, allowing passive management of the volume amount of water present in the gravel pack(s) of said at least one planted filter,
the residence management means and the overflow means allowing hydraulic management (filling/emptying) of the basin containing said at least one planted filter, which results in an alternating phases of saturation (anaerobic) and oxygenation (aerobic) and in the production of at least one planted filter with saturated/unsaturated flow.

25. The treatment facility, as claimed in claim 24, wherein said treatment facility comprises more precisely:
means for collecting wastewater, in particular at least household wastewater, preferentially by gravity, configured to feed the pretreatment module,
means for transferring the pretreated water to the phytodepuration treatment module, these transfer means advantageously comprising at least one self-cleaning lifting pump in combination with a lifting column,
means for collecting the purified water and for conveying it to the storage means fitted with the microbiological disinfection means transforming the purified water into treated water,
means for recirculating said treated water into at least one circuit for supplying with water the toilet flushes in the building and/or at least one device for watering or irrigating crops, for example plants, window boxes and/or cultivated green spaces or amenity areas, located in or around said building, and/or for discharging the treated water into the external purification or sewerage network.

26. The treatment facility as claimed in claim 25, wherein the lifting column is configured and dimensioned so as to create a Venturi effect during the transfer of the pretreated water to the phytodepuration treatment module, thereby oxygenating the pretreated water within said lifting column.

27. The treatment facility as claimed in claim 24, wherein the pretreatment module, positioned within the lower part or cellar of the building, for example in a technical room in the basement together with the storage tank and possibly at least a portion of their accessory equipment, comprises:
at least one separation means configured to physically separate, by mechanical means, the wastewater from solid waste, notably food or organic waste, and,
at least one means for storing the wastewater, optionally fitted with a mechanical filtration means, the discharge of which is preferentially directed by gravity toward the transfer means.

28. The treatment facility as claimed in claim 27, wherein the separation means comprises at least one self-cleaning separating filter, for example of the vortex type.

29. The treatment facility as claimed in claim 24, wherein the treatment facility comprises, at the level of the phytodepuration treatment module, means for dispersion and surface distribution of the pretreated water.

30. The treatment facility as claimed in claim 24, wherein the feeding of the planted filter(s), with combined [vertical+horizontal] flow, is performed by dispersion and surface distribution means, the treatment module also comprising overflow means.

31. The treatment facility as claimed in claim 24, wherein the means for transferring the pretreated water to the phytodepuration treatment module are configured and controlled to perform feed-water tank feeding of the planted filter(s) and in that the means for collecting the purified water and for conveying it to the storage means are configured and controlled to perform, in a controlled manner or at regular intervals corresponding to a pre-programmed residence time, partial or total emptying of the purified water from the planted filter(s), resulting in alternating phases of filling and emptying of the phytodepuration treatment module.

32. The treatment facility as claimed in claim 24, wherein the phytodepuration treatment module comprises a single planted filter which includes a single gravel pack planted with plants and subjected to alternating phases of filling and partial or total emptying.

33. The treatment facility as claimed in claim 24, wherein the phytodepuration treatment module comprises at least two planted filters, either arranged in series and thus forming two successive filtration stages of the module, or arranged and fed in parallel, the two planted filters then being subjected alternately to successive phases of filling and partial or total emptying.

34. The treatment facility as claimed in claim 24, wherein the or each planted filter of the phytodepuration treatment module comprises at least two gravel packs planted with plants, which are positioned in parallel and fed in parallel, these gravel packs being located in a single compartmentalized basin thus forming a planted filter with a unitary structure, or in several separate basins, thus constituting a planted filter with a modular structure, the various gravel packs being advantageously fed and drained alternately.

35. The treatment facility as claimed in claim 24, wherein the or each gravel pack comprises a plant growth substrate of the inert, small-sized mineral aggregate type, for example a 20 cm layer of pozzolan or charcoal with a particle size of 3/6 mm, and is planted with plants belonging to hardy marsh species, known as halophytic-type macrophytes, for example selected from iris, carex, bulrushes, purple loosestrife and meadowsweet.

36. The treatment facility as claimed in claim 25, wherein the means for collecting and conveying the purified water present at the outlet of the or of at least the two gravel pack(s) comprise means for managing the residence time of the pretreated water within the planted filter(s) of the phytodepuration treatment module.

37. The treatment facility as claimed in claim 24, wherein the storage means comprises a means for managing the volume and regulating the supply of water.

38. The treatment facility as claimed in claim 24, wherein the microbiological disinfection means comprises a means for injecting a disinfectant solution and a means for monitoring the degree of disinfection of the purified water.

39. The treatment facility as claimed in claim 38, wherein the means for monitoring the disinfection of the purified water comprises a means for continuously checking the operating status of the means for injecting a disinfectant solution.

40. The treatment facility as claimed in claim 24, wherein the microbiological disinfection means is configured to ensure a microbiological quality of the treated water in accordance with the criteria of current health regulations, for the intended use.

41. The treatment facility as claimed in claim 24, wherein the discharge and/or recirculation means comprise a means for additional checking of the microbiological quality of the treated water.

42. The treatment facility as claimed in claim 24, wherein the discharge and/or recirculation means comprise a network of pipes configured to direct the treated water toward the circuit(s) for supplying with water the toilet flushes of the building and/or of at least one plant and/or green space watering device located in or around said building and/or toward the external purification or sewerage network.

43. The treatment facility as claimed in claim 24, wherein the discharge and/or recirculation means also comprise, upstream of said at least one circuit for feeding with water local toilet flushing and/or watering devices, additional mechanical filtration means in the form of a sieve filter and/or a zeolite filter.

44. The treatment facility as claimed in claim 24, wherein the pretreatment module, of which a storage means for wastewater and/or the storage means for purified water form(s) a preferential part, comprises at least one overflow discharge system opening out into the purification network.

45. The treatment facility as claimed in claim 24, wherein only the phytodepuration treatment module is installed on the roof of the building, the pretreatment module with its buffer storage tank for wastewater and the storage tank for purified water, and possibly other components of the facility, being arranged in a technical room or analog in the basement of said building.

46. A building, notably a tertiary or residential building, for catering or collective housing, said building comprises a facility for treating wastewater, in particular or exclusively of the household wastewater type, produced by its occupants, as claimed in claim 24.

47. A treatment facility as claimed in claim 24 with a phytodepuration treatment module which comprises a single planted filter which includes a single gravel pack planted with plants, wherein the planted filter is subjected to alternating phases of filling and partial or total emptying.

48. A treatment facility as claimed in claim 24 with a phytodepuration treatment module which comprises at least two planted filters, either arranged in series and thus forming two successive filtration stages of the module, or arranged and fed in parallel, wherein the two planted filters are subjected to successive alternating phases of filling and partial or total emptying.
